(19) United States
(12) Patent Application Publication
(10) Pub. No.: US 2012/0257008 A1
(43) Pub. Date: Oct. 11, 2012

(54) Mobile Device Case Having an Integrated Wide-Angle Lens

(76) Inventor: Andrew David Taylor, Santa Cruz, CA (US)

(21) Appl. No.: 13/441,564

(22) Filed: Apr. 6, 2012

Related U.S. Application Data
(60) Provisional application No. 61/516,721, filed on Apr. 7, 2011.

(51) Int. Cl. H04N 5/225

(52) U.S. Cl. 348/36; 348/E05.026

(57) ABSTRACT

A case for a mobile device is provided, which may advantageously include an integrated wide-angle lens for photography and/or videography. The mobile device case includes a protective casing with an opening that exposes a mobile device camera, where the mobile device camera has a default angle of view. The protective casing encloses the mobile device and may include one or more hinges and one or more locking mechanisms. A wide-angle lens is integrated within the protective casing of the mobile device case. In some embodiments, the wide-angle lens is removably attached to the protective casing of the mobile device. The wide-angle lens provides a wider angle of view to the mobile device camera than the default angle of view. Furthermore, the wide-angle lens is positioned a predetermined distance from the mobile device camera. The wide-angle lens, in some embodiments, is a fisheye lens.

### CROSS-REFERENCE TO RELATED APPLICATIONS

This application claims the priority benefit of U.S. provisional patent application No. 61/516,721, filed Apr. 7, 2011 and entitled, “Protective Phone Case That Has A Built-In Wide Angle Lens for Filming,” which is being incorporated herein by reference.

### BACKGROUND

1. Field of the Invention

The present invention relates generally to cases for mobile devices, and more particularly to cases that have an integrated wide-angle lens.

### SUMMARY

A case for a mobile device is provided, which may advantageously integrate a wide-angle lens for photography and/or videography. The mobile device case includes a protective casing that has an opening that exposes a mobile device camera, where the mobile device camera has a default angle of view. The protective casing encloses the mobile device and may include one or more hinges and one or more locking mechanisms. A wide-angle lens is integrated within the protective casing of the mobile device case. In some embodiments, the wide-angle lens is removably attached to the protective casing of the mobile device. The wide-angle lens provides a wider angle of view to the mobile device camera than the default angle of view. Furthermore, the wide-angle lens is positioned a predetermined distance from the mobile device camera. The wide-angle lens, in some embodiments, is a fisheye lens.

### BRIEF DESCRIPTION OF THE DRAWINGS

FIG. 1 displays a top view of an exemplary case for a mobile device having an integrated wide-angle lens.

FIG. 2 displays a perspective top view of an exemplary case for a mobile device having an integrated wide-angle lens with the case open.

FIG. 3 displays a perspective top view of an exemplary case for a mobile device having an integrated wide-angle lens with the wide-angle lens removed from the mobile device case.

FIG. 4 displays an exploded view of an exemplary wide-angle lens.

FIG. 5 displays a transparent cross-section view of an exemplary case for a mobile device having an integrated wide-angle lens with a mobile device enclosed therein.

FIG. 6 displays a flowchart of an exemplary method for providing a mobile device case that integrates a wide-angle lens.

### DETAILED DESCRIPTION

A case for a mobile device may be used to provide mobile devices with a wide-angle lens. A mobile device often includes a camera which has the ability to record photographs and/or video.

The mobile device camera may include at least one lens and an image sensor. Often, this mobile device lens is a fixed-focus lens. The fixed-focus lens may be given a non-adjustable focus at the time that the mobile device is manufactured. In addition, a mobile device camera has a default field of view. The field of view of a camera is the visible extent of the scene recorded by the image sensor, stated as an angle.

The mobile device case includes a protective casing with an opening that exposes the mobile device camera. The wide-angle lens is integrated within the protective casing and is located in the opening of the protective casing that exposes the mobile device camera, thereby covering at least part of the mobile device camera. The wide-angle lens provides a wider angle of view than that provided by the mobile device camera, and the wide-angle lens has a fixed position that is located a predetermined distance (e.g., 0.5 millimeter, 1 millimeter, 2 millimeters) from the mobile device camera.

By having the wide-angle lens integrated in the mobile device case, a user may simultaneously protect a mobile device from damage caused by environmental stresses (e.g., shock and water) while engaging in wide-angle photography and/or videography using the camera on the mobile device. This is especially advantageous if the user is engaging in a sporting activity such as snowboarding, skiing, or biking and wants to record photographs and/or video while he/she is participating in the sporting activity. In an embodiment of the mobile device case, the mobile device case is waterproof. This application is related to U.S. non-provisional patent application Ser. No. 13/359,373, filed Jan. 26, 2012 and entitled, “Waterproof Protective Case for a Mobile Device,” which is being incorporated herein by reference.

Because a wide-angle lens has a wider angle of view than a mobile device lens, a wide-angle lens allows a user to record more images from a scene into a photograph and/or video without the user having to move farther from the scene to record the desired images. This is especially desirable when the user is participating in a sporting activity and is recording his/her participation on video and/or in a photograph, because the user can participate in the sporting activity without having to take into consideration the placement of his/her mobile device camera relative to the scene(s) to be recorded by the mobile device camera.

In addition, because the user may be participating in a sporting activity while recording his/her participation in a photograph and/or on video, the user may want to secure the mobile device case to his/her person. In order for the user to secure the mobile device to his/her person, the mobile device case may utilize a mounting system (e.g., rail mounting system, suction cup mounting system, or an adhesive mounting system). This application is related to U.S. provisional patent application No. 61/591,244, filed Jan. 26, 2012 and entitled, “Providing a Rail Mounting System for a Mobile Device Case,” which is being incorporated herein by reference.

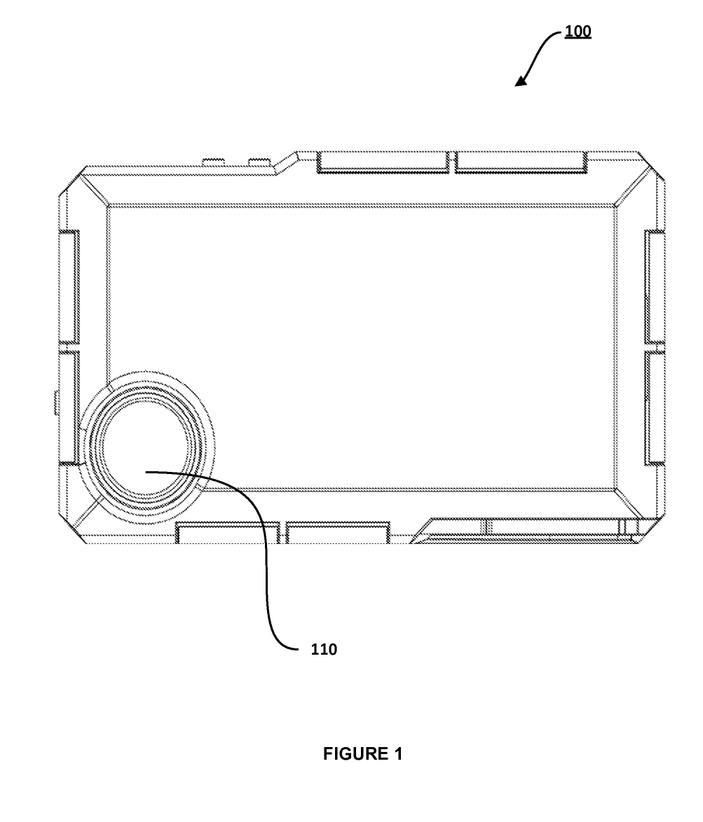

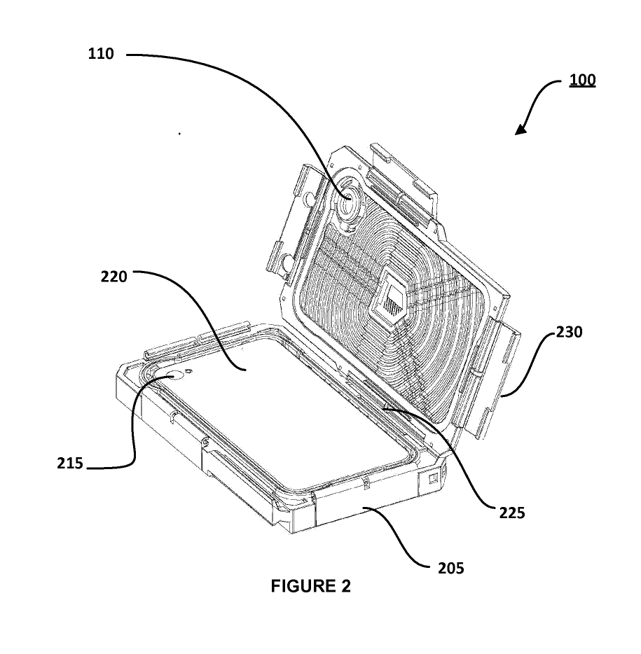

FIG. 1 displays a top view of an exemplary mobile device case 100 having an integrated wide-angle lens 110. FIG. 2 displays a perspective top view of an exemplary mobile device case 100 having an integrated wide-angle lens 110 with the case open. FIG. 2 also displays a view of mobile device camera 215 of mobile device 220. A mobile device 220 may be placed in the mobile device case 100. In the illustrated embodiment, a protective casing 205 of the mobile device case 100 is shown, as is hinge 225 and locking mechanism 230. The protective casing 205 may include at least one hinge 225, which may be any suitable hinge allowing the protective casing 205 to alternate between open and closed positions. The at least one hinge 225 may be a barrel hinge, a case hinge, or any other hinge type that allows for at least two positions (e.g., an open and a closed position).

The protective casing 205 may include at least one locking mechanism 230. The locking mechanism 230 may be any suitable device configured to hold the protective casing in a closed position. The locking mechanism 230 may include, for example, one or more latches, fasteners, or locks.

Mobile device case 100 may be of any appropriate size to receive the mobile device 220. Mobile device case 100 may also be composed of any suitable material and/or combination of materials, such as plastic, metal, and rubber. In an exemplary embodiment, the mobile device case 100 or a portion thereof may be composed of a shock-absorptive material, such as rubber or foam. While encased in the mobile device case 100, external forces, such as impacts from being dropped, may be absorbed by shock-absorptive material, thereby providing protection to the mobile device 220 from shock. The mobile device case 100 may also be water-resistant, by virtue of encasing the mobile device 220 and thereby reducing exposure of the mobile device 220 to external contaminants. In an exemplary embodiment, the mobile device 220 may be surrounded by the shock-absorptive material. Furthermore, in some embodiments, mobile device case 100 may be designed to float on water, which may be advantageous to further reduce exposed of mobile device case 100 to liquid and thereby increase the useful life of mobile device case 100.

As stated above, mobile device case 100 may be used to protect mobile device 220. Mobile device 220 may be any portable electronic device having a display and a mobile device camera 215. Examples of mobile devices that may be used with embodiments of mobile device case 100 may include but are not limited to portable computers, portable game consoles, portable music players, tablets, iPods®, iPhones®, Smartphones, portable navigation systems, and other similar devices. A Smartphone may be generally defined as a phone with computing capability. A Smartphone may provide Internet access to an end user.

Mobile device 220 used with the embodiments of mobile device case 100 may include mobile device camera 215, which is capable of capturing photographs and/or video. As stated above, mobile device camera 215 of mobile device 220 may include a mobile device camera lens and an image sensor.

The mobile device lens may be made of glass, quartz glass, fluorite, plastic, acrylic, germanium, or meteoritic glass. The mobile device lens may be a normal, non-distorting lens. In 35-millimeter photography, a normal, non-distorting lens may have a focal length of 50 millimeters. The mobile device lens may be a photographic lens for which the focus is not adjustable. In some embodiments, the mobile device lens is set to the hyperfocal distance, so that the depth of field ranges all the way down from half the hyperfocal distance to infinity. A hyperfocal distance is the distance beyond which all objects can be brought into an “acceptable” focus.

The standard of 35-millimeter photography is popular, and as such, camera-lens combinations are often described in terms of their 35-millimeter equivalent focal length. The 35-millimeter equivalent focal length is the focal length of a lens that would have the same field of view if used on a full-frame 35 millimeter camera. Use of a 35-millimeter equivalent focal length is particularly common with digital cameras. Digital cameras often use sensors smaller than 35 millimeter film, and so require correspondingly shorter focal lengths to achieve a given angle of view. An embodiment of mobile device camera 215 may be a digital camera.

An embodiment of mobile device camera 215 may utilize also a fixed-focus lens. A fixed-focus lens relies on a sufficient depth of field to produce satisfactorily sharp images for photographs and/or video. This may require the user of the mobile device camera to adjust his position with the mobile device camera (e.g., move farther away from the scene to be recorded using the mobile device medium) in order to take a satisfactorily sharp photograph and/or video.

As stated above, mobile device camera 215 may utilize an image sensor, as well as a mobile device lens. The image sensor detects the light which comes through the lens and converts it into electrical signals. Any suitable image sensor may be used in the mobile device camera 215, including one or more CCD (charge coupled device) sensors and one or more a CMOS (complementary metal-oxide-semiconductor) sensors. The strength of the electrical signal may depend upon the intensity of the light detected by the image sensor. Electrical signals generated by the image sensor may be processed through a series of complex electronic circuits, and these electrical signals are stored as image data in a type of internal or external flash memory in a standard image file format such as a JPEG (Joint Photographic Experts Group) file, GIF (Graphics Interchange Format) file, or BMP (Bitmap Image) file. When processed by a computer, the files that include the image data may reproduce an image which may be able to be printed on photographic paper. The files that include the image data may also be replayed in some embodiments to reproduce a moving image for a video.

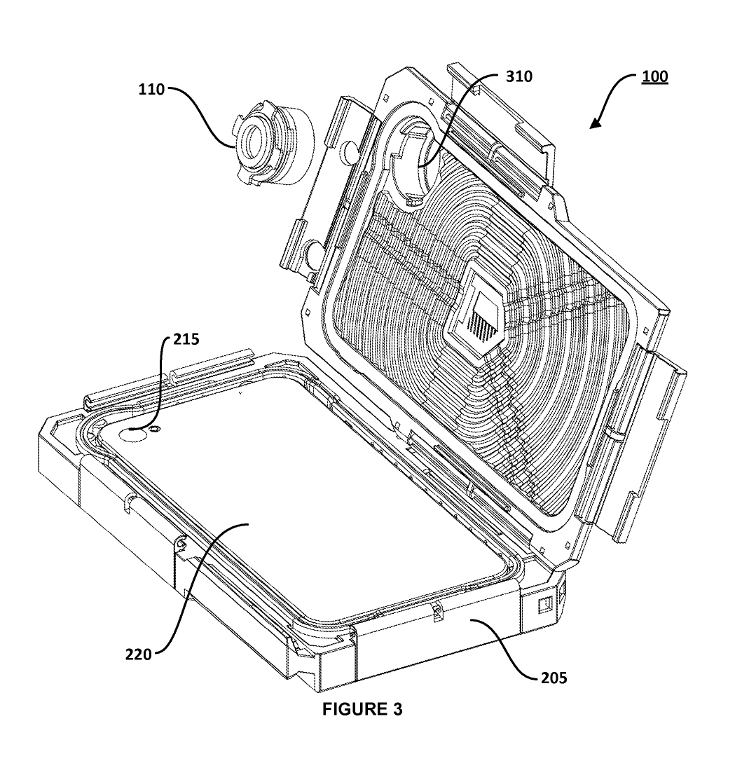

FIG. 3 displays a perspective top view of an exemplary mobile device case 100 having an integrated wide-angle lens 110 with the wide-angle lens 110 removed from the mobile device case 100. FIG. 3 also displays an opening 310 in the protective casing 205 of mobile device case 100. When mobile device case 100 has enclosed mobile device 220, opening 310 may expose mobile device camera 215 of mobile device 220. Opening 310 may be of any shape or size corresponding to mobile device camera 215. In the embodiment of opening 310 shown in FIG. 3, opening 310 is larger than mobile device camera 215. As shown in FIG. 3, opening 310 may be configured to receive a wide-angle lens 110, which may be removably attached from protective casing 205. “Removable attachment” describes a situation in which two or more objects may be coupled or attached to each other, and the coupling or attachment is not permanent.

Wide-angle lens 110 is a lens whose focal length is smaller than the focal length of the lens of the mobile device camera 215. As stated above, the lens of the mobile device camera 215 may be a normal, non-distorting lens. In 35-millimeter photography, a normal, non-distorting lens may have a focal length of 50 millimeters. Wide-angle lens 110 may be made of glass, quartz glass, fluorite, plastic, germanium, or meteoritic glass. Wide-angle lens 110 may allow more of a scene to be included in a photograph and/or on video than the lens of the mobile device camera 215 would otherwise allow. As stated above, this is especially advantageous if the user of the mobile device camera is participating in a sporting activity, as wide-angle lens 110 allows the user to record his/her participation in the sporting activity without having to adjust either his/her position or the position of the mobile device camera accordingly. Wide-angle lens 110 is also helpful if the user wishes to emphasize a difference in size or distance between objects in the foreground and objects in the background. Nearby objects may appear large and objects at a moderate distance appear small and far way when viewed through the wide-angle lens 110. In addition, wide-angle lens 110 may magnify the distance between objects recorded in the photograph and/or video, while allowing greater depth of field.

The wide-angle lens 110 may be a lens that has a shorter focal length and a wider field of view than the lens of mobile device camera 215. The focal length of the lens is the distance between the lens and the image sensor when the subject is in focus. The focal length is usually given in millimeters (e.g., 28 millimeters, 50 millimeters, or 100 millimeters). In exemplary embodiments of wide-angle lens 110, wide-angle lens 110 has a focal length of less than 45 millimeters. In some embodiments, wide-angle lens 110 has a focal length greater than 18 millimeters. Wide-angle lens 110 may be a lens whose focal length is shorter than the diagonal of the film frame. In 35-millimeter photography, wide-angle lens 110 may be a lens shorter than 50 millimeters.

As stated above, the standard of 35-millimeter photography is popular, and as such, camera-lens combinations are often described in terms of their 35-millimeter equivalent focal length. The 35-millimeter equivalent focal length is the focal length of a lens that would have the same field of view if used on a full-frame 35 millimeter camera. As such, an embodiment of the wide-angle lens may have a 35-millimeter equivalent focal length of less than 45 millimeters. In this embodiment, the wide-angle lens may have a 35-millimeter equivalent focal length of greater than 18 millimeters.

In some embodiments, wide-angle lens 110 may have an adjustable field of view. A field of view is the area that is visible through an optical instrument, such as a lens. The field of view may be adjusted to the desired angle, and as such, the field of view may be adjusted anywhere from 180 degrees to the default field of view of the lens of mobile device camera 215. The field of view may be adjusted to a desired angle, such as 38 degrees, 42 degrees, and 55 degrees. In an embodiment of wide-angle lens 110, the field of view may be adjusted by the user removing wide-angle lens 110 from protective casing 205 and adjusting the field of view manually. The field of view of wide-angle lens 110 may also be adjusted by the user manipulating an object on the mobile device case 100 that allows the user to adjust the field of view of the wide-angle lens 110. The object on the mobile device case 100, when manipulated, changes the field of view of the wide-angle lens 110 to the desired field of view. The object on the mobile device case 100 which may allow the user to adjust the field of view of the wide-angle lens 110 may be a lever, button, switch, or barrel.

In some embodiments, wide-angle lens 110 may be a fisheye lens. A fisheye lens is a wide-angle lens that takes in a broad, panoramic and hemispherical image for a photograph and/or video. In 35-millimeter photography, the focal length of fisheye lens may be between 8 millimeters and 10 millimeters for circular images, and between 15 and 16 millimeters for full-frame images, making the focal length of a fisheye lens less than 18 millimeters. In digital cameras, the focal length of fisheye lenses may be as short as 1 to 2 millimeters. The fisheye lens may have a 35-millimeter equivalent focal length of less than 18 millimeters.

As shown in FIG. 3, and as stated above, wide-angle lens 110 may be removably attached from opening 310 in protective casing 205. A user may wish to remove wide-angle lens 110 in order to clean the wide-angle lens 110 and/or the opening 310 in protective casing 205. Removable attachment can be achieved through the use of a screw thread, bayonet mount, or another means of removable attachment. In the embodiment of wide-angle lens 110 shown in FIG. 3, a bayonet mount is used to provide removable attachment. A bayonet mount may be a fastening mechanism including a cylindrical male side with one or more radial pins, a female receptor with one or more matching L-shaped slots and one or more springs to keep the male side and female receptor locked together. The “L” in the slots may have a serif at the end, the serif being a short upward segment at the end of the horizontal arm of the “L.” To couple the parts, the one or more pins on the male side may be aligned with the one or more slots on the female side, and the male side and female side may be pushed together. Once the pins reach the bottom of the slot, one of or both of the male and the female parts may be rotated so that the pin slides along the horizontal arm of the “L” until it reaches the serif. The spring may then push the male connector up into the serif to keep the pin locked into place. To disconnect, the male and female parts may be pushed together to move the pin out of the serif. One of or both the male and female parts may then be twisted in the opposite direction from the direction used for coupling, and then pulled apart from each other. In an embodiment of wide-angle lens 110 and opening 310, wide-angle lens 110 utilizes the cylindrical male side of the bayonet mount and opening 310 utilizes the female receptor of the bayonet mount. In an alternative embodiment, wide-angle lens 110 utilizes the female receptor of the bayonet mount and opening 310 utilizes the cylindrical male side of the bayonet mount.

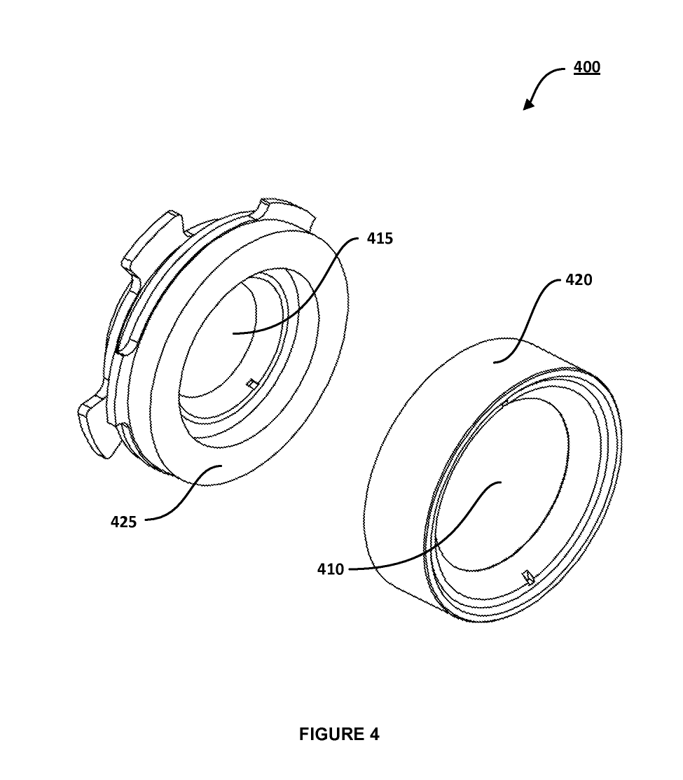

FIG. 4 displays an exploded view of exemplary wide-angle lens 400. Wide-angle lens 400 may be composed of a group of one or more lens elements. In the illustrative embodiment of wide-angle lens 400, one or more lens elements may be detached from wide-angle lens 400, leaving the residual group of lens elements integrated within the casing. This residual group of lens elements may comprise one or more lens elements, such as, for example, a biconcave lens 410 and a biconvex lens 415.

Spherical lenses may be used as lens elements within the wide-angle lens 400, and may include two surfaces. The curves on the surfaces of a spherical lens, if extrapolated in all directions, may form a ball or perfect sphere, with the lens axis ideally perpendicular to both surfaces. Each surface can be convex, concave, or planar. A convex surface may bulge outward from the lens. A concave surface may be depressed into the lens. A planar surface may be a flat surface. The line joining the centers of the spheres making up the lens surfaces may be the axis of the lens. Some lens element may be aspherical. Aspherical lenses are lenses in which one or both surfaces have a shape that is neither spherical nor cylindrical. A macro lens may be a type of aspherical lens. In exemplary embodiments of wide-angle lens 400, wide-angle lens 400 may include one or more aspherical lenses and one or more spherical lenses.

In the embodiment of wide-angle lens 400 shown in FIG. 4, wide-angle lens 400 includes a biconcave lens 410 and a biconvex lens 415. In the embodiment shown in FIG. 4, biconcave lens 410 is in closer proximity to mobile device camera 215 than biconvex lens 415 is to mobile device camera 215. In an alternative embodiment, biconvex lens 415 is in closer proximity to mobile device camera 215 than biconcave lens 410 is to mobile device camera 215. Biconcave lens 410 is a lens with two concave surfaces. Biconvex lens 415 is a lens with two convex lenses. As shown in the embodiment in FIG. 4, the edges of biconcave lens 410 may be covered by a lens housing 420. Lens housing 420 may provide structural support and protection to biconcave lens 410. Similarly, as shown in the embodiment in FIG. 4, the edges of biconvex lens 415 may be covered by a lens housing 425. Lens housing 425 may provide structural support and protection to biconvex lens 415. Lens housing 420 and lens housing 425 may be composed of plastic or any other material. Additionally, lens housing 420 and lens housing 425 may be composed of the same material.

Biconcave lens 410 and biconvex lens 415 may be removably attached to each other, through the use of a screw thread, bayonet mount, or another means of removable attachment. A screw thread may be a helical structure used to convert between rotational and linear movement or force. A screw thread may be a ridge wrapped around a cylinder or cone in the form of a helix, with the former being called a straight thread and the latter called a tapered thread. Every matched pair of threads, external and internal, can be described as male and female. An embodiment of wide-angle lens 400 utilizing the screw thread method may include lens housing 420 having male threads and lens housing 425 having female threads. In an alternative embodiment of wide-angle lens 400 utilizing the screw thread method, lens housing 420 may have female threads and the lens housing 425 may have male threads. In either embodiment, when the male and female threads are coupled, lens housing 420 and lens housing 425 are removably attached to each other and form the wide-angle lens 400.

In an embodiment of biconvex lens 415, biconvex lens 415 is a macro lens. A macro lens may be a type of aspherical lens. A macro lens may be used for close-up photography or videography of any subject, especially a subject that is very small in size (e.g., a fruit fly, a pebble, or an ant). As such, biconvex lens 415 may be used individually by removing lens housing 420 from lens housing 425.

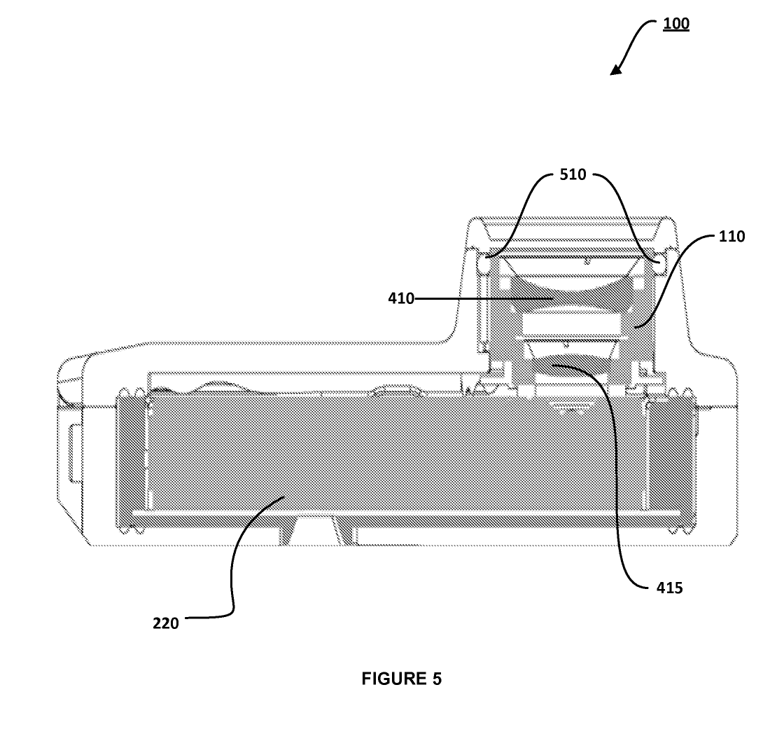

FIG. 5 displays a transparent cross-section view of an exemplary mobile device case 100 having an integrated wide-angle lens 110 with a mobile device 220 enclosed therein. Cross-sectional views of biconcave lens 410 and biconvex lens 415 are shown as well. FIG. 5 also shows a cross-sectional view of an O-ring 510. O-ring 510 may be a loop made of elastic material, such as nitrile rubber or other types of rubber. In the embodiment shown in FIG. 5, O-ring 510 is wedged between wide-angle lens 110 and protective casing 205. In another embodiment, O-ring 510 may be radially compressed between wide-angle lens 110 and protective casing 205. Radial compression is the result of the subjection of a material or structure to compressive stress, the compressive stress applied in the shape of rays or the radii of a circle, which results in reduction of volume as compared to an uncompressed but otherwise identical state. The O-ring 510 may be placed in this position in order to keep wide-angle lens 110 from undesired movement in the mobile device case 100. O-ring 510 may also serve as a cushion to protect wide-angle lens 110 from damage in the mobile device case 100.

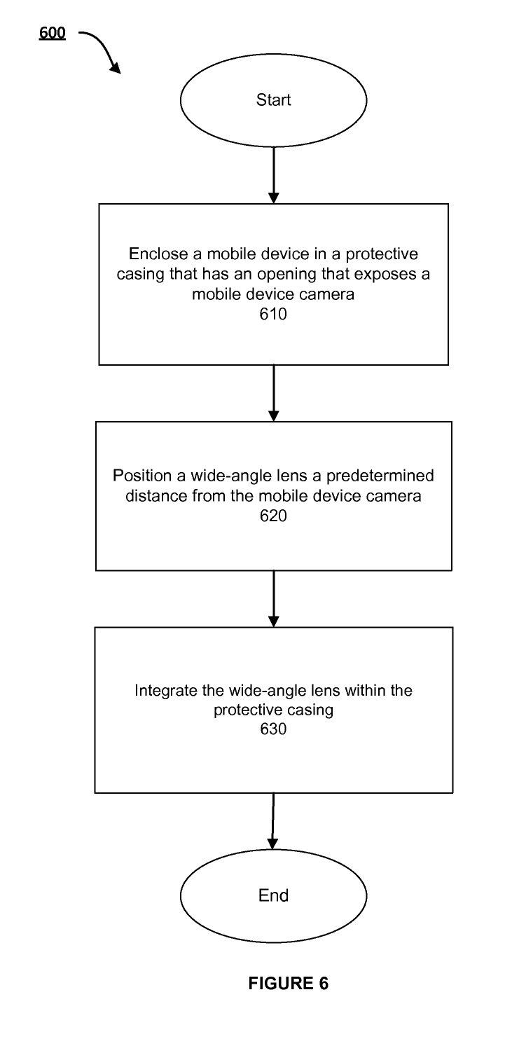

FIG. 6 displays a flowchart of an exemplary method 600 for providing a mobile device case 100 that integrates a wide-angle lens 110. A mobile device 220 is enclosed by a protective casing 205 at step 610. The protective casing 205 may comprise an opening 310 that exposes a mobile device camera 215. The mobile device camera 215 may have a default angle of view. A wide-angle lens 110 is positioned a predetermined distance from the mobile device camera 215 at step 620. In another embodiment, the wide-angle lens 110 may be positioned a predetermined distance from the image sensor of the mobile device camera 215. The wide-angle lens 110 is integrated within the protective casing 205 at step 630. The wide-angle lens 110 may provide a wider angle of view than the default angle of view for the mobile device camera 215.

While the present invention is disclosed by reference to the preferred embodiments and examples detailed above, it is to be understood that these examples are intended in an illustrative rather than a limiting sense. It is contemplated that modifications and combinations will readily occur to those skilled in the art, which modifications and combinations will be within the spirit of the invention and the scope of the following claims.

What is claimed is:

1. A mobile device case comprising:
a protective casing for a mobile device comprising an opening that exposes a mobile device camera, the mobile device camera having a default angle of view, in which the protective casing encloses the mobile device; and
a wide-angle lens integrated within the casing, wherein the wide-angle lens provides a wider angle of view to the mobile device camera than the default angle of view, and in which the wide-angle lens is positioned a predetermined distance from the mobile device camera.

2. The mobile device case of claim 1, in which the wide-angle lens is removably attached to the protective casing.

3. The mobile device case of claim 1, in which the wide-angle lens has a 35-millimeter equivalent focal length of less than 45 millimeters.

4. The mobile device case of claim 3, in which the wide-angle lens has a 35-millimeter equivalent focal length of greater than 18 millimeters.

5. The mobile device case of claim 1, in which the wide-angle lens is a fisheye lens.

6. The mobile device case of claim 5, in which the wide-angle lens has a 35-millimeter equivalent focal length of less than 18 millimeters.

7. The mobile device case of claim 1, in which the protective casing is waterproof.

8. The mobile device case of claim 1, in which the protective casing is at least partially composed of a shock-absorptive material that surrounds the mobile device to provide shock protection.

9. The mobile device case of claim 1, in which the wide-angle lens comprises a group of one or more lens elements.

10. The mobile device case of claim 9, in which the wide-angle lens comprises one or more aspherical lenses and one or more spherical lenses.

11. The mobile device case of claim 9, in which a subset of the group of one or more lens elements may be detached from the lens, leaving a residual group of lens elements integrated within the casing, the residual group of lens elements comprising one or more lens elements.

12. The mobile device case of claim 11, in which the residual group of lens elements comprise a macro lens.

13. The mobile device case of claim 11, in which the residual group of lens elements are removably attached.

14. The mobile device case of claim 1, in which an O-ring is radially compressed between the wide-angle lens and the protective casing.

15. A method of providing a mobile device case, the method comprising:
enclosing the mobile device in a protective casing, the protective casing comprising an opening that exposes a mobile device camera having a default angle of view;
positioning a wide-angle lens a predetermined distance from the mobile device camera; and
integrating the wide-angle lens within the protective casing, thereby providing the mobile device camera with a wider angle of view than the default angle of view.

16. The method of claim 15, in which the wide-angle lens has a 35-millimeter equivalent focal length of less than 45 millimeters.

17. The method of claim 16, in which the wide-angle lens has a 35-millimeter equivalent focal length is greater than 18 millimeters.

18. The method of claim 15, in which the wide-angle lens is a fisheye lens.

19. The method of claim 15, in which the wide-angle lens is removably attached to the protective casing.

20. The method of claim 15, in which the protective casing is at least partially composed of a shock-absorptive material that surrounds the mobile device to provide shock protection.

21. The method of claim 15, in which the wide-angle lens comprises a group of one or more lens elements.

22. The method of claim 21, in which a subset of the group of one or more lens elements may be detached from the lens, leaving a residual group of lens elements integrated within the casing, the residual group of lens elements comprising one or more lens elements.

23. The method of claim 22, in which the residual group of lens elements comprise a macro lens.

24. The method of claim 22, in which the residual group of lens elements is removably attached to the protective casing.

25. The method of claim 15, in which an O-ring is radially compressed between the wide-angle lens and the protective casing.
